(19) United States
(12) Patent Application Publication
(10) Pub. No.: US 2014/0289047 A1
(43) Pub. Date: Sep. 25, 2014

(54) SELECTIVE BANNER AD DISPLAY

(71) Applicants: Danny Yee, San Jose, CA (US); Egan Schulz, San Jose, CA (US)

(72) Inventors: Danny Yee, San Jose, CA (US); Egan Schulz, San Jose, CA (US)

(21) Appl. No.: 13/930,588

(22) Filed: Jun. 28, 2013

Related U.S. Application Data
(60) Provisional application No. 61/805,083, filed on Mar. 25, 2013.

(51) Int. Cl. G06Q 30/02

(52) U.S. Cl. CPC G06Q 30/0261
USPC 705/14.58

(57) ABSTRACT

When a user launches a service provider app on a user device, but before authentication, the user may be presented with an ad or offer, which is dependent on and relevant to the user. The service provider determines which ad to present to the user based on factors such as time of day, time of year, location of user, speed of travel of user, user purchase history, user favorites, saved offers, size of merchant, user actions from previous ads, expiration dates of saved offers, etc. Once an ad is determined, the ad is presented to the user on the user device. In one embodiment, the ad is displayed when the user launches an app of the service provider or accesses the service provider site, such as through a mobile browser. the user does not have to launch an app or access a site for an ad to be displayed. After viewing the ad, the user can accept an offer from the ad or otherwise make a purchase based on the ad, such as by logging into the user account (e.g., entering a password or PIN) and making a payment.

### CROSS REFERENCE TO RELATED APPLICATION

Pursuant to 35 U.S.C. §119(e), this application claims priority to the filing date of U.S. Provisional Pat. Application Ser. No. 61/805,083, filed Mar. 25, 2013, which is incorporated by reference in its entirety.

### BACKGROUND

1. Technical Field

The present application generally relates to ad selection.

2. Related Art

Users of consumer devices, such as smart phones, PCs, and computing tablets, typically receive offers, ads, and other incentives to encourage the user to make a purchase. Such offers may be based on different factors, such as when the user is close to a certain merchant or when an offer of interest to the user is determined.

One problem is that the user may be presented with numerous ads that the user may not be interested in, which inconveniences or annoys the user, as well as possibly cause the user to ignore or lose relevant offers in the numerous ads.

### BRIEF DESCRIPTION OF THE DRAWINGS

FIG. 1 is a flowchart showing a process a service provider makes in presenting a selected ad to a user according to one embodiment;

FIG. 2 is a partial screen shot showing a banner ad according to one embodiment;

FIG. 3 is block diagram of a networked system suitable for implementing the process described herein according to an embodiment; and

FIG. 4 is a block diagram of a computer system suitable for implementing one or more components in FIG. 3 according to one embodiment.

### DETAILED DESCRIPTION

In one embodiment, when a user launches a service provider app on a user device, but before authentication, the user may be presented with an ad or offer, which is dependent on and relevant to the user. The service provider determines which ad to present to the user based on factors such as time of day, time of year, location of user, speed of travel of user, user purchase history, user favorites, saved offers, size of merchant, user actions from previous ads, expiration dates of saved offers, etc. Once an ad is determined, the ad is presented to the user on the user device. In one embodiment, the ad is displayed when the user launches an app of the service provider or accesses the service provider site, such as through a mobile browser. In another embodiment, the user does not have to launch an app or access a site for an ad to be displayed. After viewing the ad, the user can accept an offer from the ad or otherwise make a purchase based on the ad, such as by logging into the user account (e.g., entering a password or PIN) and making a payment.

In another embodiment, more than one ad is presented, but the number should be limited due to the size of the user device display and other factors. For example, more ads may result in the user less likely to focus on the ads. A single ad is more likely to cause the user to spend more time considering the ad, but a single ad may not be desirable in a situation where the user is not interested in the ad presented, but may have been interested in another ad, which could have been presented at the same time. In one embodiment, the number of ads is also based on the user, e.g., based on history of ad acceptance, the service provider may determine that the particular user likes more ads or that another user prefers single ads. Thus, the user is provided an ad specifically relevant to the user.

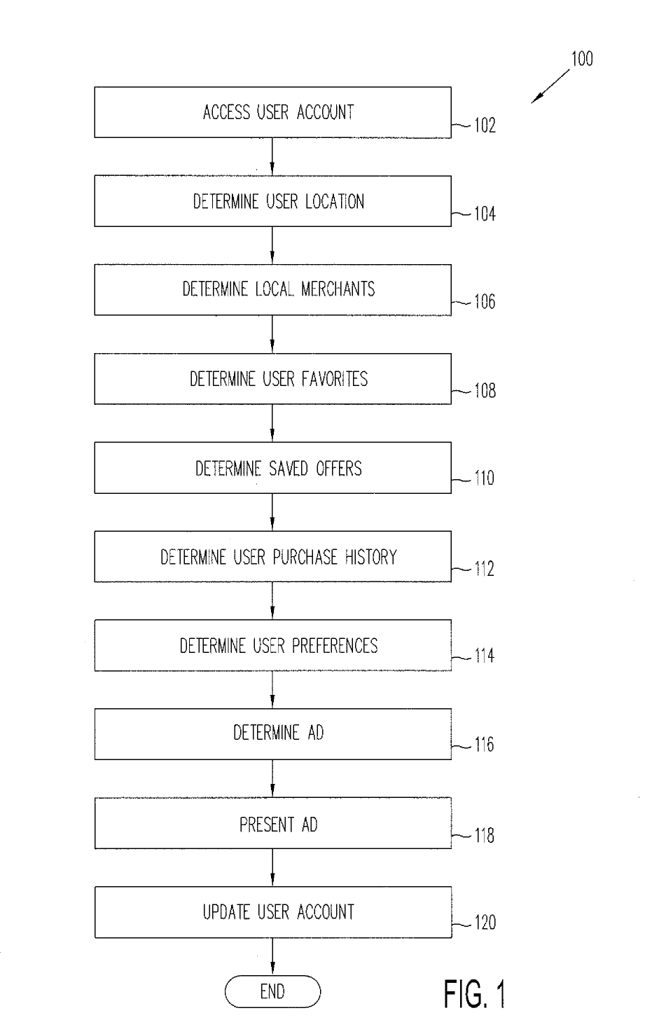

FIG. 1 is a flowchart 100 showing a process a service provider makes in presenting a selected ad to a user according to one embodiment. At step 102, the service or payment provider accesses a user's account. For example, the user may launch a mobile app of the service provider from the user device, which may be a smart phone, PC, computing tablet, or other computing/communication device. Launching the app allows the service provider to receive certain information from the user device, such as a phone number, device ID, or other identifying information. Using this information, the service provider may locate and access the user's account associated with the device or identifier. In one embodiment, the user has not yet been authenticated, e.g., the user has not entered an authentication credential such as a password or PIN. In another embodiment, information may be received when the user accesses a site or page of the service provider, such as through a URL address via a browser on the user device.

At step 104, the user location is determined by the service provider, such as through a location feature of the user device. The user may also enter a specific location through the user device, which is communicated to the service provider. The entered location may be a current location of the user or an expected location of the user. For example, the user may be planning to be at or near a certain location at a certain time, which would allow the user to see an ad or ads beforehand to determine whether something may be of interest to the user when the user arrives at the location.

Once the user location is determined, the service provider determines, at step 106, merchants in proximity to or within a certain distance from the user location. The distance may vary depending on the user location and/or the user rate/speed of travel. For example, if the user is in a densely populated shopping area, the distance may be shorter than if the user is in a sparsely populated rural area. One reason is that there will be fewer merchants in the rural area such that a longer distance is used to return a sufficient number of merchants to make a better determination of a relevant ad or ads for the user. In the densely populated shopping area, a large distance would not be needed to return a sufficient number of merchants, and in fact, could return merchants that are located too far for the user to consider.

In one embodiment, the service provider also determines a user's rate or speed of travel, such as based on movement or location change of the user device. For example, if the device location has not changed or has been confined within a certain radius, the service provider may assume the user is relatively stationary or focused within a certain area. If the device location has changed in certain direction, but the change in distance is not large over a certain period of time (e.g., half of a mile over 30 minutes), the service provider may assume the user is walking in a general direction. If the device location has changed greatly over a certain period of time (e.g., 5 miles over 8 minutes), the service provider may assume the user is driving on streets. If the device location has changed even more greatly (e.g., 5 miles over 5 minutes), the system may assume the user is traveling on a freeway. Thus, based on change of location over a certain period of time (and direction is relevant), the service provider may be able to make a better determination of a user-relevant ad or ads. Other information may indicate the user is traveling in a car, train, bus, motorcycle, bicycle, or other vehicle.

With a relatively stationary user or a slow-moving user not headed in a general direction (e.g., one wandering around an area), the merchants searched may be within a certain radius of the user, i.e., merchants in all directions of the user with the user at the center. However, with a directionally moving user, the merchants searched may only be in the direction of user travel, with the assumption that the user will not want to back track to shop, but would want to continue forward on the current route of travel. This may be especially the case where the user is determined to be traveling on a highway or freeway, where it would be inconvenient for the user to get off the freeway, go back in the opposite direction to shop, and get back on the freeway in the original direction.

In embodiment, the distance from the user location to merchants is 0.2 miles. In another embodiment, the distance is 1 mile. As noted above, different distances can be used, or a single distance used for all conditions. The local merchants may be ranked based on distance from the user, with the closest merchant ranked first.

Next, favorite merchants of the user are determined at step 108. This information may be available in the user's account. For example, the user may have specifically designated one or more merchants as “Favorites.” Favorite merchants may be inferred as ones where the user has made numerous purchases, although favorite merchants may also be ones where the user has made no purchases, such as merchants most visited by the user. The favorite merchants may be compared with the local merchants determined at step 106 to obtain a subset of favorite merchants local to the user. The merchants may be ranked according to various factors, such as, but not limited to, size, volume of sales, volume of inventory, distance to user, etc.

A determination is also made, at step 110, as to whether there are any offers saved by the user. Offers may be saved by the user to the user's account or digital wallet, using known methods. The saved offers may be searched to determine whether any saved offers are with local merchants found at step 106, with user favorite merchants, or a subset of local merchants who are also user favorite merchants. Saved offers found may then be ranked using various factors, such as most recent expiring, largest discount, most relevant to a user wish list item, redeemable at a user favorite merchant, redeemable at the closest merchant to the user, redeemable with an in-store offer by a merchant, etc.

Next, at step 112, the user purchase history is determined, such as from previous transaction information stored with the user account. Relevant history information may include merchants the user purchases most from and/or spends the most dollars with, times or days when the user typically makes purchases, whether the purchases are made online or in person, the dollar amount of typical purchases, more purchases through large merchants or smaller merchants, purchases made at “regular” prices or more purchases made on sale items and/or with coupons and other incentives, etc. This information may be used to further rank the local merchants. For example, if the user typically shops at larger name-brand stores, such stores may be ranked higher than a small boutique store even though the small boutique store may be slightly closer to the user.

User preferences are also determined, at step 114. User preferences may be specifically set by the user, such as informing the service provider that the user prefers to shop at night, online, on vacation, after work, on weekends, during lunch hour, at small stores, items that are reduced over a certain percentage from their regular price, make larger purchases on paycheck clays, etc. Preferences can also be inferred or determined by the service provider through user shopping actions. For example, if most of the user's purchases are made on weekends, the system can assume the user prefers to shop on weekends. If most of the user's purchases are made at small stores, the system may assume the user prefers smaller stores to large stores.

Using the information thus determined, the service provider may determine an ad, at step 116, to present to the user. In one embodiment, only one ad is presented, and in another embodiment, only two ads are presented, although in other embodiments, more than two ads may be presented. One or more ads is determined based on what the service provider thinks will be of most interest to the user based on information about the user, such as the current time and location of the user, rate/direction of travel, saved offers, favorite merchants, distance to merchants, user preferences, etc. First, only local merchants are considered. Then, of those local merchants, a determination is made as to which one will be most interesting or appealing to the user. If all other factors are equal or substantially, the merchant closest to the user may have its ad selected. The most interesting or appealing ad may be one the service provider determines is most likely to be used or acted upon by the user, such as acceptance of an offer or shopping/making a purchase at a merchant associated with the ad.

The following provides some non-limiting examples of ad determination. If all relevant merchants are approximately equidistant from the user, then a restaurant or food merchant ad may be selected if the time is during breakfast, lunch, or dinner. If time is not a factor for the specific user, the ad for the larger or higher daily volume store may be selected if the user prefers to shop at larger, busier stores, as determined by purchase history, user favorites, saved offers, and/or user preferences. In another example, a favorite merchant's ad is selected. If there are no local favorite merchants, the merchant having a user saved offer is chosen. If there are no local merchants having a user saved offer, the merchant where the user has shopped at before, most recently shopped at, or most frequently shopped at is selected.

If the user has two favorites that are approximately equidistant, the ad for the merchant where the user has a saved offer may be selected. In another example, the local merchant having a user saved offer may have its ad selected, even if the user has shopped previously at one or more of the local merchants. If the user has multiple saved offers, the offer with the most recent expiration date may be selected, the offer that provides the biggest savings may be selected, or an offer based on another criteria may be selected. In yet another example, the local merchant that the user has shopped at the most has its ad selected. If the user has been buying a lot of snow skiing equipment and accessories, an ad or store for similar products may be selected. As can be seen, different combinations of factors can be used to determine an ad or ads to present to the user.

Once an ad or ads is determined, the ad(s) are presented to the user on the user device at step 118. As noted above, a single ad presented may carry more impact, but two or more ads give the user more options. The size of the user device display may also be a factor, as smaller devices may only display one ad, while a user device with a larger display may show two or more ads. Thus, even if the user is the same, but the user device is different, the number of ads shown may differ. In one embodiment, the service provider and/or the user may determine how many ads to present and the number can vary depending on the ads. For example, during a heavy shopping time or day for the user, more ads may be presented. If several coupons are expiring that day, multiple ads/coupons may be presented. The ad may be presented on the user device essentially when the user opens the app, although there may be some imperceptible delay due to ad determination. The service provider may change the number of ads presented based on user behavior. For example, if the user ignores all ads when more than three ads are presented, reviews at least one ad 50% of the time when three ads are shown, and reviews at least one ad 90% of the time when one ad is shown, the service provider may only present one ad at a time to the user in the future.

When the user sees the ad(s), the user may act on it or ignore it. With the former, the user may tap on or otherwise select the ad to view more information about the ad/incentive, including redeeming the ad or making a purchase using the ad. The user may then log into the user account through the app, such as by entering a PIN or password and proceed with a payment to the merchant using the user account. If the user chooses to ignore the ad, the user may tap on an “X,” “Ignore,” or other button, tab, or link, and the ad will go away. The user may also perform a gesture on these portions or other designated or suitable portions of a display to remove the ad. Gestures may include swiping up or down or across to hide an ad. The user may also provide feedback such as through a thumbs down button, thumbs up button, “like” button, “dislike” button, and/or other indicators.

The user response to the ad(s) is received and the user account updated, at step 120, based on the response. For example, if the ad is accepted or used, similar ads or ads from the same or similar merchants may be prioritized higher for subsequent ad determinations. On the other hand, if the user dismisses, ignores, or dislikes the ad, similar ads or ads from the same or similar merchants may be ranked lower for subsequent ad determinations. In one example, if the user dismisses the ad for the first time, the same ad (or another ad) will not be presented until a certain time has passed, such as not until the next session or after a one-session delay. If the user again dismisses the ad (same or different ad), the next ad may not be presented until the next day or some other increased period. If the user still dismissed the ad (same or different), the user may not be presented an ad until a week later (or other period). In one embodiment, if the user dismisses an ad three times, an alert is sent to the user asking whether the user wants to continue receiving ads. If no response is received, no more ads are presented in one embodiment.

In other embodiments, the user may be asked, at various times, whether the user wishes to receive ads. If so, the user may be asked to specify which types of ads are of interest to better provide relevant ads to the user. The requests may be sent when the user ignores, dismisses, or dislikes an ad the first time or a certain number of subsequent times.

Information may also be gathered when the user accepts, uses, or likes an ad. The user may be asked whether the user wishes to receive ads from the same merchant, same type of ad, etc., to better provide relevant ads in the future. Thus, even if a user does not use or accept an ad, the ad may still be of interest to the user. For example, the user may not have the time to review the ad when presented, but would be have at another time or day. Consequently, being able to indicate a “like” provides valuable information to the service provider.

Note that one or more steps described herein may be omitted, combined, or performed in a different sequence as desired.

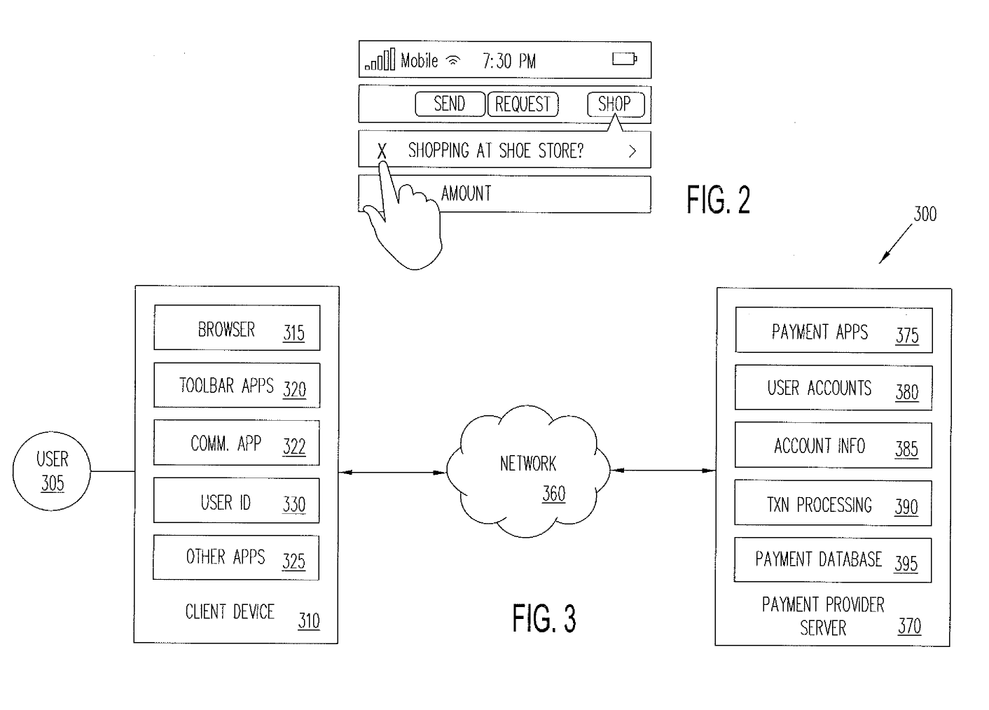

FIG. 2 is an exemplary screen shot of a partial display on a user device showing an ad presented to the user on the user device. The screen shot is part of a display on a smart phone and shows a banner ad “Shopping at Foot Locker,” although the ad can take other forms indicating the merchant and any other relevant information as desired. In one embodiment, the ad or banner ad simply asks the user whether the user is or is interested in shopping at a particular local merchant, where the merchant is offering the ad or incentive determined by the service provider as most relevant to the user. As seen in FIG. 2, there is a portion of the ad the user can select to use or get more information about the ad, such as tapping the “Shop” button or the right arrow. An “X” allows the user to dismiss the banner by tapping on the “X.”

FIG. 3 is a block diagram of a networked system 300 configured for displaying selective ads, such as offers, as described above, in accordance with an embodiment of the invention. System 300 includes a user device 310 and a payment provider server 370 in communication over a network 360. Payment provider server 370 may be maintained by a payment provider, such as PayPal, Inc. of San Jose, Calif. Although a payment provider device is shown, the server may be managed or controlled any suitable service provider that requires authentication as a human before communicating information. A user 305 utilizes user device 310 to view account information and perform transactions using payment provider server 370. Note that transaction, as used herein, refers to any suitable action performed using the user device, including payments, transfer of information, display of information, etc. Although only one server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 310 and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks, For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet, such as ads presented by the payment provider. User device 310 may also include one or more toolbar applications 320 which may be used, for example, to provide client-side processing for performing desired tasks in response to operations selected by user 305. In one embodiment, toolbar application 320 may display a user interface in connection with browser application 315.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate and transfer information through and with the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider. A communications application 322, with associated interfaces, enables user device 310 to communicate within system 300.

Payment provider server 370 may be maintained, for example, by an online payment service provider which may provide information to and receive information from user 305, such as for making payments, viewing ads, and responding to ads. In this regard, payment provider server 370 includes one or more payment applications 375 which may be configured to interact with user device 310 over network 360 to facilitate ad transactions with user 305 of user device 310.

Payment provider server 370 also maintains a plurality of user accounts 380, each of which may include account information 385 associated with consumers, merchants, and funding sources, such as credit card companies. For example, account information 385 may include private financial information of users of devices such as account numbers, passwords, device identifiers, user names, phone numbers, credit card information, bank information, identification cards, photos, offers available to the user, or other information which may be used to facilitate transactions by user 305. Account information may also include purchase history, preferences, and user ad responses.

A transaction processing application 390, which may be part of payment application 375 or separate, may be configured to receive information from a user device for processing and storage in a payment database 395. Transaction processing application 390 may include one or more applications to process information from user 305 for processing a payment or transfer using various selected funding instruments or cards. As such, transaction processing application 390 may store details of payment transfer from individual users, including funding source(s) used, offers, credit options available, etc. to other individuals or entities. Payment application 375 may be further configured to determine the existence of and to manage accounts for user 305, as well as create new accounts if necessary, such as the set up and management payments by the user.

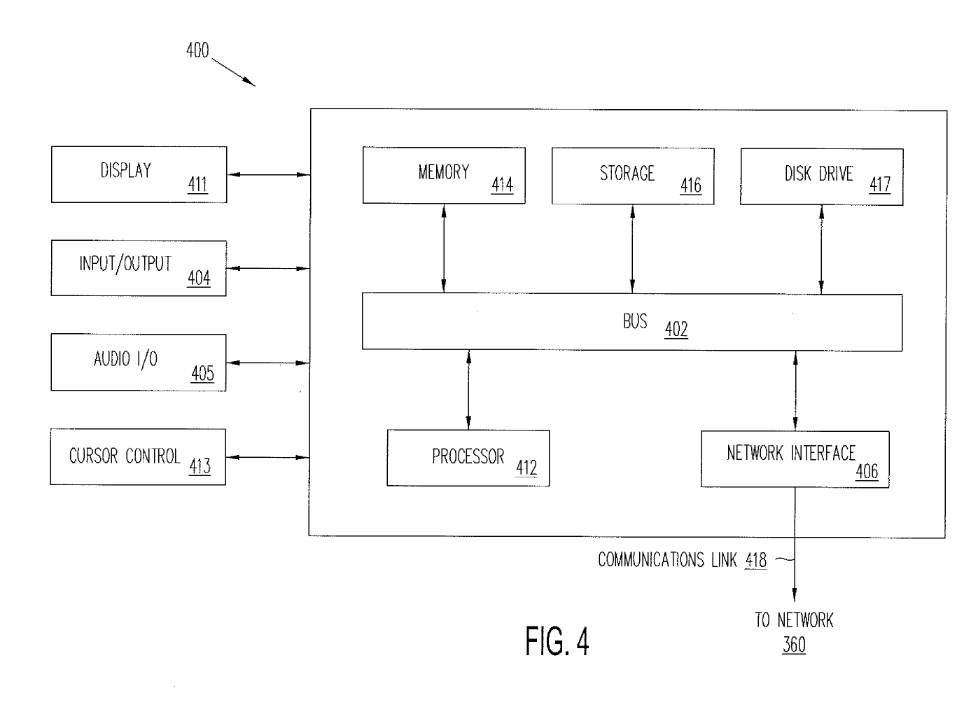

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, FDA, Bluetooth device, key FOB, badge, etc.) capable of communicating with the network. The payment provider may utilize a network computing device (e.g., a network server) capable of communicating with the network. It should be appreciated that each of the devices utilized by users and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the information comprises at least one of user favorite merchants, user saved offers, user purchase history, and user preferences; and
one or more hardware processors in communication with the non-transitory memory and configured for:
determining a location of a user;
determining a plurality of merchants within a predetermined distance from the user;
determining an ad to present to the user based on the at least one of user favorite merchants, user saved offers, user purchase history, and user preferences;
communicating, to a user device, the ad; and
receiving an indication of what the user did with the ad.

2. The system of claim 1, wherein no other ads are presented to the user device with the ad.

3. The system of claim 1, wherein the predetermined distance is dependent on a rate of user movement.

4. The system of claim 1, wherein the one or more hardware processors is further configured for determining a specific number of ads to present based, in part, on user preferences and a display size of the user device.

5. The system of claim 1, wherein the one or more hardware processors is further configured for determining a second ad to present to the user a subsequent time based, in part, on the indication.

6. The system of claim 1, wherein the indication comprises a dismissal, an ignore, a like, a dislike, a view, or a use of the ad.

7. The system of claim 1, wherein the ad is determined based on all of user favorite merchants, user saved offers, user purchase history, and user preferences.

8. The system of claim 1, wherein the ad is presented on the user device before the user is authenticated by a service provider presenting the ad.

9. The system of claim 8, wherein the ad is presented when the user launches a mobile app on the user device.

10. A method comprising:
determining, through a user device, a location of a user;
determining, by a hardware processor of a service provider, a plurality of merchants within a predetermined distance from the user;
determining, by the hardware processor, an ad to present to the user based on at least one of user favorite merchants, user saved offers, user purchase history, and user preferences;
communicating, to the user device, the ad; and
receiving an indication of what the user did with the ad.

11. The method of claim 10, wherein the first distance is dependent on a rate of user movement.

12. The method of claim 10, further comprising determining a specific number of ads to present based, in part, on user preferences and a display size of the user device.

13. The method of claim 10, further comprising determining a second ad to present to the user at a subsequent time based, in part, on the indication.

14. The method of claim 10, wherein the indication comprises a dismissal, an ignore, a like, a dislike, a view, or a use of the ad.

15. The method of claim 10, wherein the ad is determined based on all of user favorite merchants, user saved offers, user purchase history, and user preferences.

16. The method of claim 10, wherein the ad is presented on the user device before the user is authenticated by the service provider presenting the ad.

17. A non-transitory computer readable medium comprising a plurality of machine-readable instructions which when executed by one or more processors of a server are adapted to cause the server to perform a method comprising:
determining a location of a user;
determining a plurality of merchants within a predetermined distance from the user;
determining an ad to present to the user based on at least one of user favorite merchants, user saved offers, user purchase history, and user preferences;
communicating, to a user device, the ad; and
receiving an indication of what the user did with the ad.

18. The non-transitory computer readable medium of claim 17, wherein the indication comprises a dismissal, an ignore, a view, or a use of the ad.

19. The non-transitory computer readable medium of claim 17, wherein the ad is determined based on all of user favorite merchants, user saved offers, user purchase history, and user preferences.

20. The non-transitory computer readable medium of claim 17, wherein the ad is presented on the user device before the user is authenticated by a service provider presenting the ad.
